(19) United States
(12) Patent Application Publication
(10) Pub. No.: US 2010/0098508 A1
(43) Pub. Date: Apr. 22, 2010

(54) A Device for Preparation of Relief Surfaces and Method Thereof

(76) Inventor: Konstantin N Kulikov, Rochester, MN (US)

Correspondence Address: PATWRITE LLC, 408 W. MAIN ST., MARSHALLTOWN, IA, 50158-5759, US

(21) Appl. No.: 11/913,428

(22) PCT Filed: Dec. 29, 2006
(86) PCT No.: PCT/RU06/00715

§ 371 Date: Nov. 2, 2007

(51) Int. Cl. B23D 7/08

(52) U.S. Cl. 409/219

(57) ABSTRACT

The invention relates to decorative finishing, in particular to article finishing methods, and, more specifically, to producing shaped surfaces and pictures. The inventive method consists in orienting the rotation axis of cutting tools at angles to a blank ranging from 0° to 360° in horizontal and vertical planes, in displacing the cutting tools along three mutually perpendicular planes, one of which is positioned in parallel with the blank supply direction, wherein the blank is fed according to a predetermined program in such a way that it can be displaced in forward and inverse directions and the blank feeding speed is modifiable up to zero, the processing by the moving cutting tool is carried out within the limits of the operation area which is defined by the displacement of the moving cutting tool in longitudinal and transverse directions and by the possibility of modifying the rotational frequency of cutting tools which are spatially fixable according to the blank feeding speed.

### RELATED APPLICATIONS

This application is a Continuation in Part of the international application PCT/RU2006/000715 filed Dec. 29, 2006, the entire content of which is hereby incorporated by reference. This invention is related to the field of decorative processing, namely, to products finishing methods and, in particular, to preparation of relief surfaces and pictures.

### BACKGROUND OF THE INVENTION

There is a known method for preparation of relief surface, which involves processing the surface of a product with cutting tools shaped to provide a figure profile through their rotation around the own axes with simultaneous movement according to the given program synchronously with the product to be fed in the horizontal direction (see Patent RU No. 2181669, B44B3/00 dated Apr. 27, 2002).

The same patent also describes a device for preparation of relief surface, which consists of a stationary base and working table, mobile frame installed on the base, and product feeding device, working body installed on the mobile frame, which shaft contains the cutting tools to process the surface of a product.

The disadvantage of the known method for preparation of relief surface and device for realisation thereof is the high inertia of the mobile cutting tools. This inertia is accounted for by the fact that the mobile frame exists in static equilibrium with respect to the rotating joint, while, in order to provide this static equilibrium, the electric motor and working tool are placed on the different sides of the rotating joint (M1=M2) at a significant distance that essentially increases the moment of inertia in rotation of the whole frame (and in the course of movement it rotates around the joint), and this factor is crucial and restricts the operational speed of this device.

Neither is there an opportunity to cut outlines and figures or to mill lines orthogonally across the surface of an product or to produce cuttings with clear outlines, especially in an opposite direction with respect to the product feeding direction. Moreover, this method does not take into consideration an opportunity to process a product, while it is not moving. In this case, even if we assume that such processing takes place, then processing a product will be possible only in the tool catching zone, namely, the radius of the tool rotating around the rotation joint.

### SUMMARY OF THE INVENTION

The technical problem solved by this invention, is reduction of inertia of the cutting tools with respect to movement as well as elimination of the aforementioned disadvantages and expansion of capacities of the method and device.

This method achieves the said goal as the rotation axis of the cutting tools is oriented with respect to the product at the angles within the range from 0 to 360 degrees in horizontal and vertical planes, while movement of the cutting tools is provided in three mutually perpendicular planes, one of which is arranged in parallel to the product feeding plane; for this purpose, the product feeding is provided according to the given program with direct and reverse feeding the product and variation of the product feeding speed up to zero, whole processing with the mobile cutting tool is provided within the working zone determined by the maximum motion of the mobile cutting tool in longitudinal and transverse directions, and optional variation of rotation speed of the cutting tools, which are immobile in space, with respect to the product feeding speed.

This device achieves the given goal as it contains the mechanisms of movement in three mutually perpendicular planes of one and more spindle motors with regulated rotation speed, while movement of the spindle motors along one of coordinates coincides with the product feeding direction, and the spindle motor is designed with a holder of a standard tool attachment collar to fix another holder which is used to hold an additional spindle motor with its own servodrive in order to provide high-frequency movements of a high-speed spindle motor in the vertical direction.

Other features and advantages of the instant invention will become apparent from the following description of the invention which refers to the accompanying drawings.

### BRIEF DESCRIPTION OF THE DRAWINGS

FIG. 1 represents a device for preparation of relief surface (general view).

FIG. 2 represents a spindle motor with fixed rotor aggregate for processing in six directions.

FIG. 3 represents a spindle motor with fixed platform and own servodrive and high-speed spindle motor.

FIG. 4 represents a spindle motor transition into sloped or vertical position.

FIG. 5 represents pressing rollers before and after a cutting tool.

FIG. 6 represents a pressing roller with plate, rod and friction pads.

FIG. 7 represents view A of FIG. 6.

FIG. 8 represents fixation of a pressing roller.

FIG. 9 represents a working table in section.

FIG. 10 represents a interchangeable operating table with easily detachable plates.

FIG. 11 represents a interchangeable operating table with porous plate.

FIG. 12 represents a standard tool in the form of combined cutter installed in a spindle motor.

FIG. 13 represents arrangement of fixed laser.

FIG. 14 represents arrangement of feeding rollers.

FIG. 15 represents working scheme of a special tool in the first mode.

FIG. 16 represents working scheme of a special tool in the second mode.

FIG. 17 represents working scheme of a special tool in the third mode.

FIG. 18 represents working scheme of a special tool in the fifth mode.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

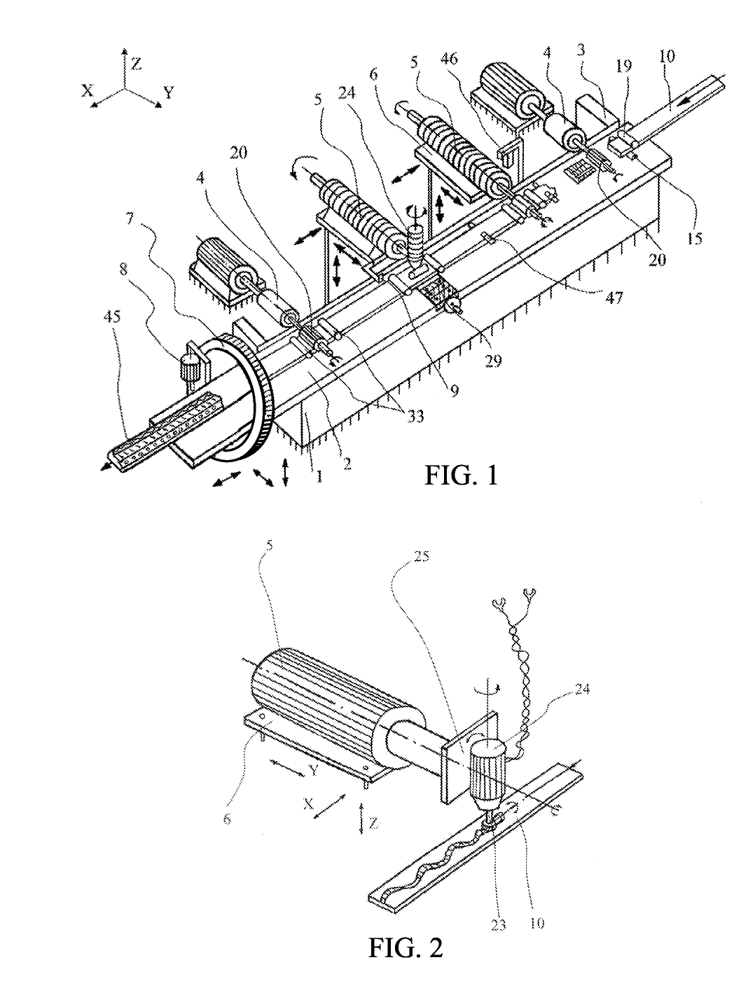

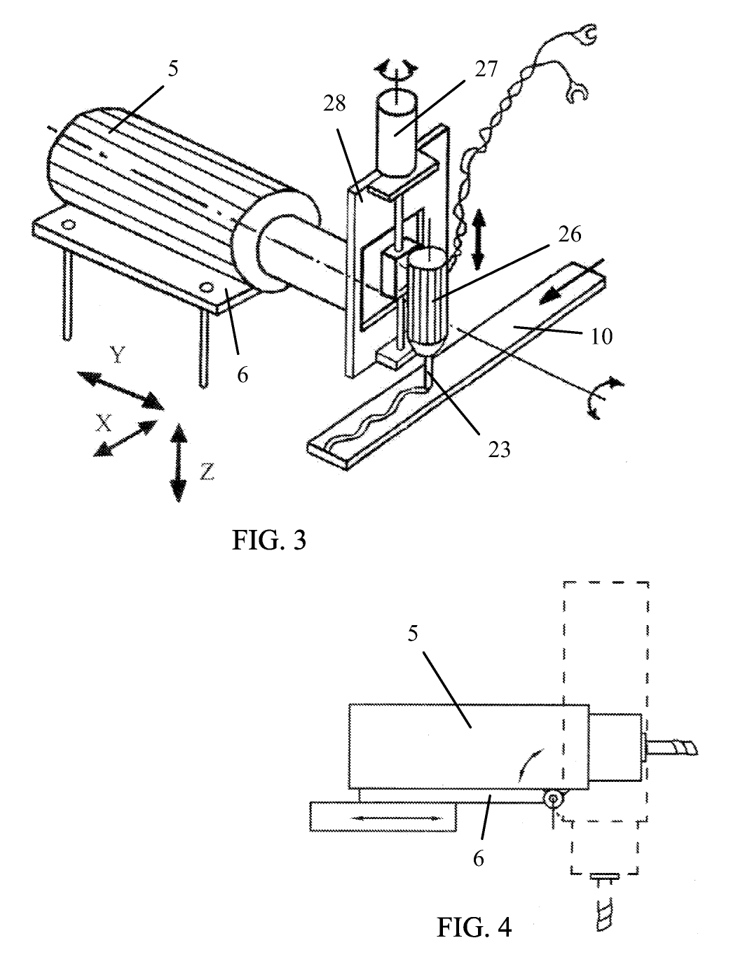

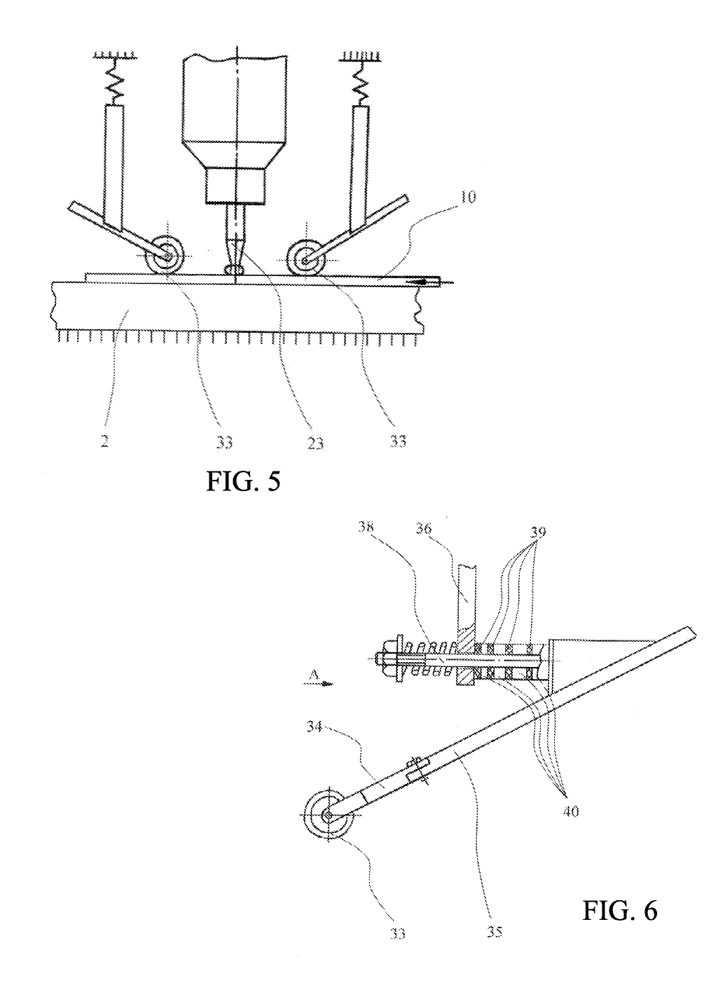

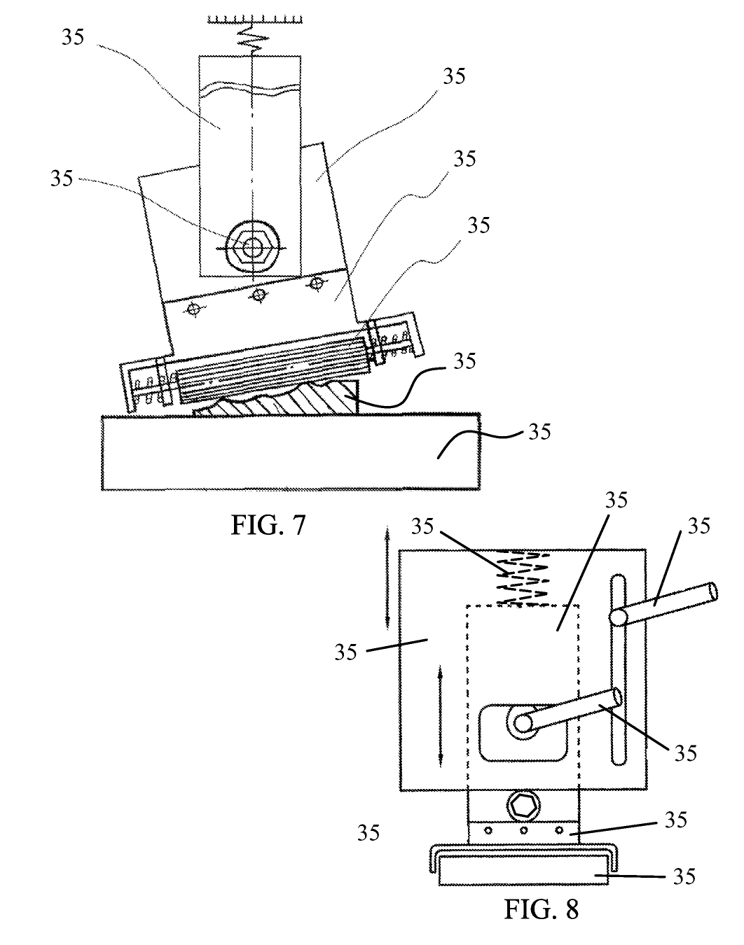

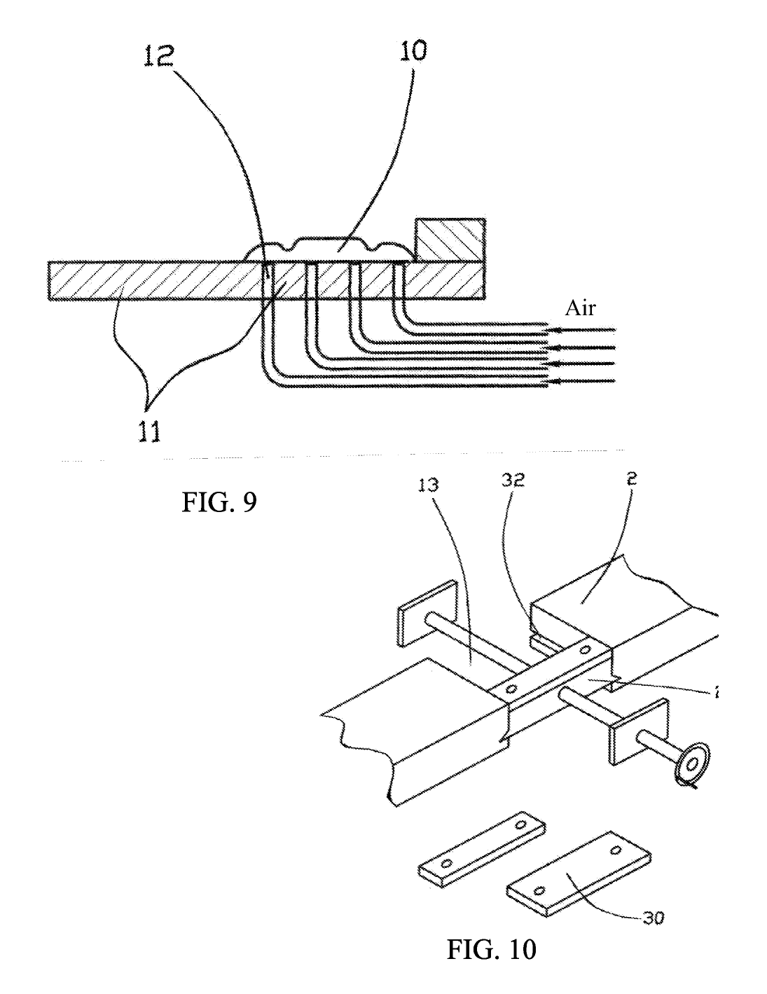

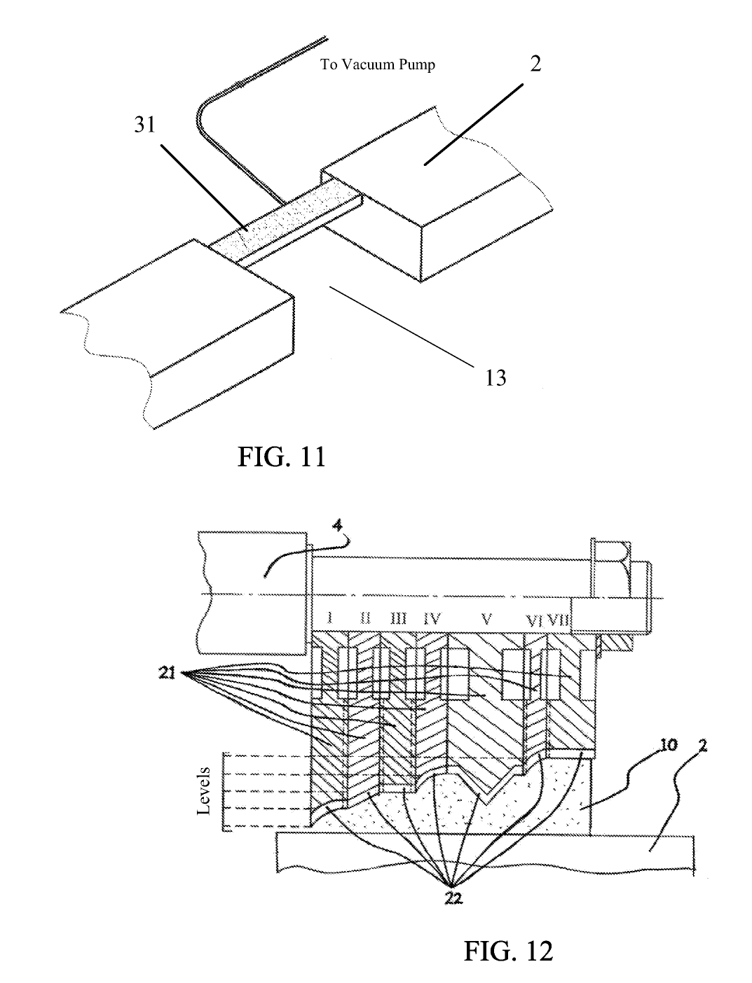

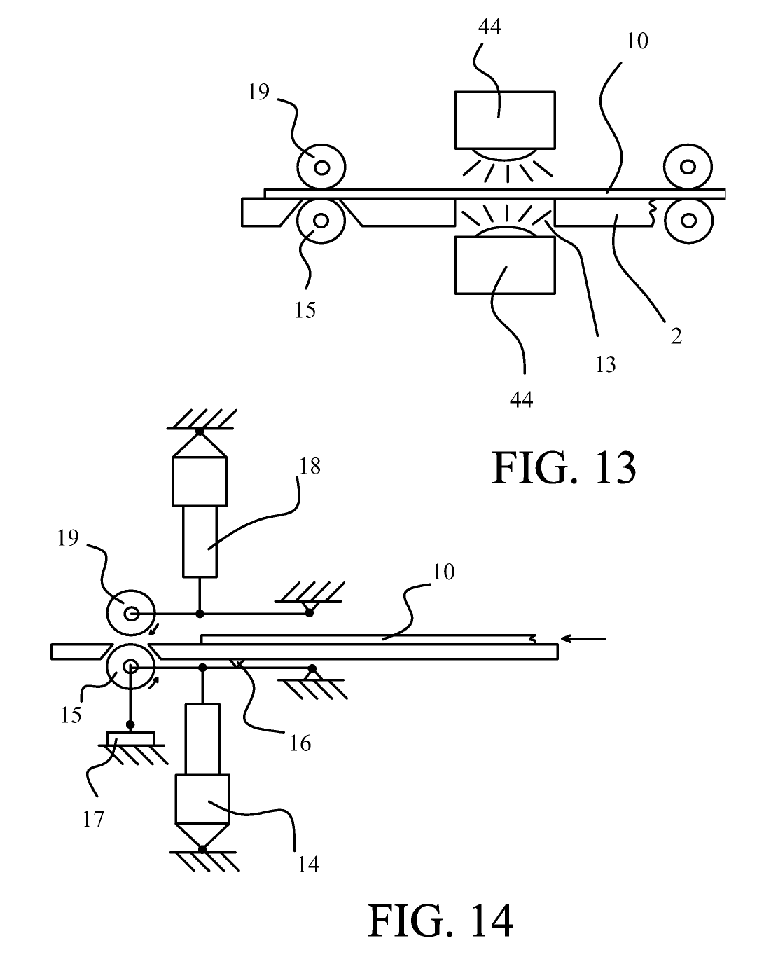

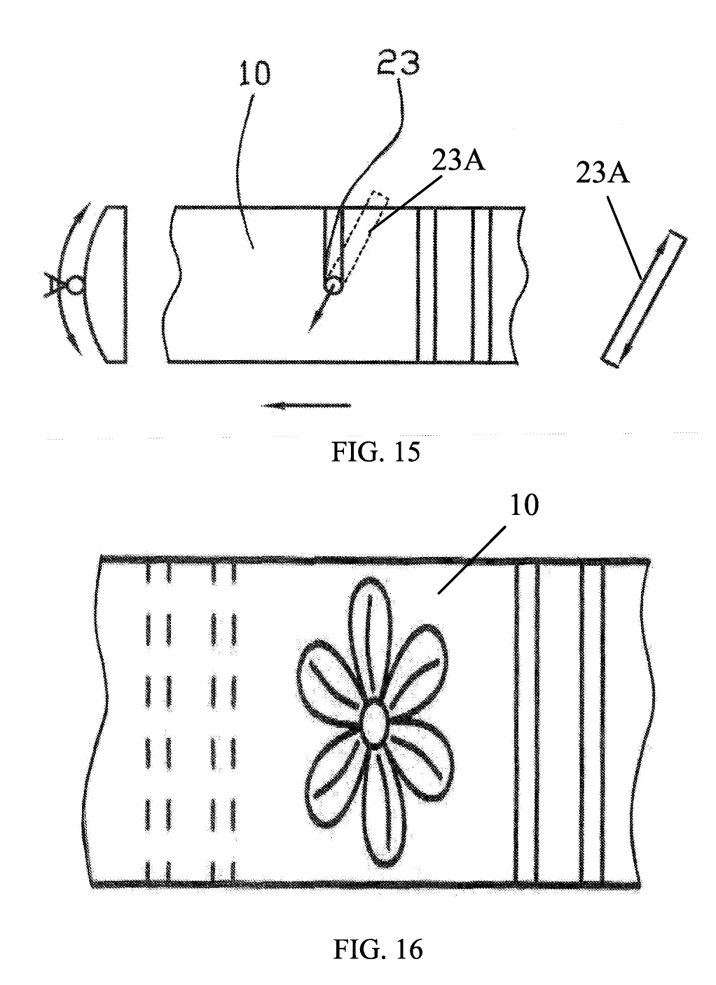

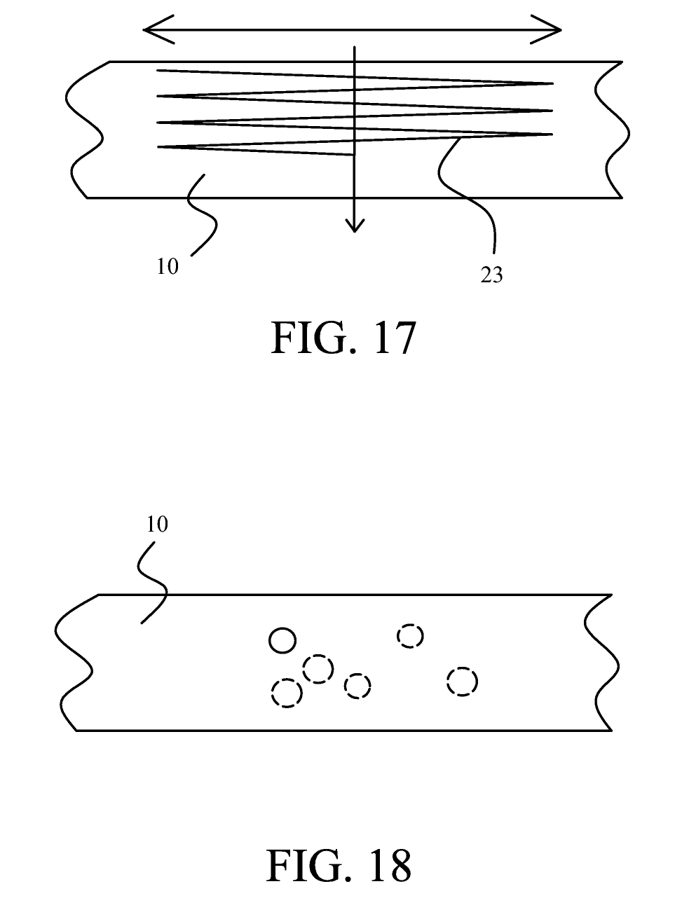

Referring to FIGS. 1 through 11, a device for preparation of relief surface contains a fixed base (1), on which working table (2), mobile frame (3), fixed spindles (4), mobile decorating spindle motors (5) on platforms (6), round support (7) with spindle motors (8), and stand with television camera (9) are installed.

A product (10) is fed on a working table (2). Working table (2) is made of at least one plate insert (11) which are selected to achieve a desired effect. A plurality of air channels (12) are disposed in the surface therein and are connected to an air source as is known in the art. Beneath the decorating spindle motors (5) working table (2) contains at least one opening (13) for interchangeable operating tables.

Disposed along working table (2) are lower feeding rollers (15) which are biased rods of pneumatic cylinders (14) and barely protrude above the surface of working table (2). The position of the lower feeding rollers (15) over the surface of the working table (2) is regulated by limiting devices (16), while the pressure on them is recorded by piezometric sensors (17) connected to the control loop of lower feeding rollers (15).

Over each of the lower feeding rollers (15), upper feeding rollers (19) are installed and biased with rods of pneumatic cylinders (18). Pneumatic cylinders (14 and 18) are always under the air pressure. Feeding rollers (15 and 19) are coated with a material, which does not damage the surface of product (10), for example, polyurethane. Feeding rollers (15 and 19) are installed in pairs; the number depends upon the length of the working table (2).

The feeding rollers (15 and 19) are necessary to provide feeding the product (10) over the working table (2). The fixed spindles (4) contain the installed standard cutting tool (20), for example, a standard cutter with straight or figure knives or a combined cutter.

A combined cutter consists of replaceable hard-alloy plates (21) with cutting edges (22) having various shape and thickness. The replaceable hard-alloy plates (21), which are arranged with potential retention of balance, are installed on each separately taken cutter at the certain cutting radius or level, if we consider the scheme with all the plates arranged in the same plane and combined into pack on spindle (4), while they are fixed therein in such a way that the levels of cutting edges (22) of the neighboring plates (21) coincide by height and partially overlap each other.

The mobile frame (3) contains the installed mobile decorating spindle motors (5) with optional movement in the vertical plane either solely or with the mobile frame (3) and with the feeding rollers (15 and 19). Fixation of the decorating spindle motors (5) is designed in such a way that they may be fixed and work in any position from horizontal to vertical.

The decorating spindle motors (5) may contain the fixed standard cutting tool (20) as described above or the special cutting tool (23). The special cutting tool (23) may be inserted into the rotor adapter (24) fixed with the mandrel (25) on the spindle motor (5) or inserted into the high-speed spindle motor (26) with their own servodrive (27) installed on the spindle motor (5) by the platform (28).

The rotor adapter (24) takes from the decorating spindle motor (5) any positions in the longitudinal direction with respect to feeding the product (10) and any sloped positions in the transverse direction with respect to feeding the product (10).

The platform (28) with its own servodrive (27) with the high-speed spindle motor (26) is designed to provide high operation speed of the special cutting tool (23) by additional sub-coordinate Z at any angle. In most cases, this sub-coordinate Z will coincide with the vertical, i.e., with main coordinate Z, which is crucial for increasing the working efficiency of this device in the whole. Meanwhile, it is not necessary to raise or lower the decorating spindle motor (5) with the mobile frame and part of fixtures; rather it is necessary only to move the high-speed spindle motor (26), which is small in size and weight.

Movement of the cutting tool (20 or 23), which is fixed in decorating spindle motor (5), is controlled by the program and any coordinate may be addressed in this way. If random number generation is used for predetermining the value of movement in each step of the cutting tool (20 or 23), a random picture is produced identical to a picture produced by manual processing.

The mobile frame (3) contains the vertically installed and arranged automatic mechanism (not indicated in the figures) with the set of cutting tools for automatic replacement on the decorating spindle motor (5) by command of the computer (not indicated in the figures). The decorating spindle motors (5) are designed with optional movement by one of coordinates in parallel to feeding the product (10).

Under each cutting tool (20 or 23), which is fixed in the decorating spindle motor (5) in the interchangeable operating table opening (13) of the working table (2), an interchangeable operating table (29) is installed to move perpendicularly to the working table (2). This movement of the interchangeable operating table (29) is provided manually or automatically.

The surface of the interchangeable operating table (29) may be formed from the easily detachable plates (30) or from the porous plate (31). The easily detachable plates (30) are fixed in the grooves (32) in the interchangeable operating table opening (13) of the working table (2) at the surface level of the working table (2). The grooves (32) may take any shape, for example, of dovetail.

Interchangeable operating table (29) is designed to provide clamping for products of many different shapes. In order to work with different products, it is only necessary to change out one interchangeable operating table (29) for another. Among the possible clamping means available include vices, jigs, air clamping devices, rotating sections, arch supporting clamps, pliable clamping surfaces and openings allowing the product to be worked on from below including easily detachable plates (30).

Easily detachable plates (30) are made of the material with low friction, for example, textolite (resin-impregnated fabric laminate) and may be of various widths. The width of the easily detachable plates (30) is selected in such a way to provide optional lowering of the special cutting tool (23) not touching the surface of the working table (2). If necessary, the easily detachable plates (30) may be replaced either all together or one by one. The side guides (not indicated in the figures) may be installed on the easily detachable plates (30), which is necessary in order to shear the edges of the product (10).

The porous plate (31) has microporous structure and acts as a vacuum press. When the porous plate (31) is installed on the interchangeable operating table (29), there arises an opportunity to fix the product (10) by virtue of vacuum generated by the vacuum pump (not indicated in the figures), while it is moving, or to attach the long product (10) to the surface of the working table (2), when the product (10) is moving by virtue of reduced vacuum.

On both sides of the cutting tool (20 and/or 23), which is attached to the fixed spindles (4) and/or to the decorating spindle motors (5), the easily detachable pressing rollers (33) are installed, which may be of various width and coated with the a material, which does not damage the surface of the product (10), for example, with polyurethane, which may be of various hardness with respect to necessity.

The pressing rollers (33) are fixed on the easily detachable plate (34), which is attached to the bearing plate (35), which, in turn, is attached to the sliding platform (36) pressed with the spring (37). Such attachment of the bearing plate (35) to the sliding platform (36) is provided through the rod (38), friction pads (39), and metal bushings (40). The sliding platform (36) is installed on the main platform (41) in such a way that its movement downwards is restricted with a cam (not indicated in the figures). For this purpose, the sliding platform (36) is attached to the main platform (41) by means of the handle (42). Changing the position of eccentric (not indicated in the figures) shall be made with handle (43). The pressing rollers (33) are installed to press the product (10) to the working table (2), its retention and prevention of vibration in the course of processing. The pressing rollers (33) are installed with optional rotation around the horizontal axis in order to provide optimum pressing the product (10) with retention of this position by virtue of prior tension of the friction pads (39).

In the end of the working table (2), by the way of movement of the product (10), the round support (7) is installed, on which the mobile spindle motor (8) is placed. The mobile spindle motor (8) takes any positions in space in order to apply a picture and/or relief to the lower and side surfaces of the product (10) with reserved optional installation of any aggregates or rotor adapters (24) with variable or fixed position of the cutting tools (20 and/or 23) in space.

In the placement zone of the cutting tools (20 and/or 23) and/or in the very end of the working table (2), the television camera (9) is installed to scan the quality of the picture and/or relief with provided optional correction of processing by the cutting tools (20 and/or 23).

Therefore, this device for preparation of relief surface contains several cutting tools, namely, standard cutting tool (20), special cutting tool (23), and cutting tool (not indicated in the figures), which is attached to the spindle motor (7). All these cutting tools together will enable to process the product (10) from all sides, i.e., the rotation axes of these cutting tools are oriented with respect to the product at the angles from 0 to 360 degrees in horizontal and vertical planes. For these purposes, the mobile cutting tool means the special cutting tool (23) attached to the mobile decorating spindle motor (5).

The device may include fixed laser (44), which may be installed over the product (10) and/or under the product (10). If the fixed laser (44) is installed under the product (10), fixed laser (44) is used to draw the mark, bar code, logotype, etc. If fixed laser (44) is installed over the product (10), fixed laser (44) is used to draw pictures, geometrical symbols and ornaments, which will be integrated into the already existing picture and/or relief.

The position of the fixed laser (44) on the working table (2) is selected with respect to the technological necessity. This device contains additionally installed position sensors (46) of the product (10). The guide rollers are indicated by position (47). This method and device for preparation of relief surface is functioning as follows.

Processing of the product (10) is started. For this purpose, the product (10) may be wholly long or consist of several shorter parts, which may be fed without interruption, i.e., end-to-end, or with breaks of any duration. The product (10) is fed to the working table (2). Air under pressure is continuously fed to the longitudinal grooves (12) of the working table (2). However, air is fed only to those of the longitudinal grooves (12), which are closed by the product (10). Such air feeding under the product (10) additionally reduces the friction against the working table (2) and thus reduces the feeding force. The product (10) is fed by means of the lower feeding roller (15) and upper feeding roller (19). The lower feeding roller (15) is insignificantly protruding over the surface of the working table (2), while the upper feeding roller (19) is placed by force in the lower position determined by the relevant limiting device (not indicated in the figures) by virtue of the pneumatic cylinders (14 and 18), which remain continuously under the air pressure.

When the product (10) is caught by the feeding rollers (15 and 19), the piezometric sensor (17) connected to the kinematic scheme of the lower feeding rollers (15) as if balances the product (10), i.e., calculates the load applied to the lower feeding roller (15). The computer compares this load with the load given by the operator. Then a command is sent to the pressure regulator (not indicated in the figures) of the pneumatic cylinder (14), and pressure is adjusted in this pneumatic cylinder (14) until the value of the force pressing to the piezometric sensor (17) complies with the value given by the operator.

In the event that the piezometric sensor (17) indicates “zero”, it means that, regardless of the force applied to the product (10) between the feeding rollers (15 and 19), the product (10) produces virtually no pressure to the working table (2) and, therefore, in this case, the sliding friction is absent.

The air pressure in the pneumatic cylinder (18) is given by the operator and will determine the force applied to the product (10) between the feeding rollers (15 and 19). The piezometric sensor (17) should be installed and adjusted in such a way that the zero reference point corresponds to the top position of the lower feeding roller (15) at the surface level of the working table (2), i.e., the piezometric sensor (17) will read the load values only when the product (10) is placed between the feeding rollers (15 and 19) and when the upper feeding roller (19) as if overpresses the lower feeding roller (15).

In the event that there is no product (10) placed between the feeding rollers (15 and 19), then, under the air pressure, the lower feeding roller (15) stays in the top position determined by the limiting device (16). In this case, the piezometric sensor (17) does not read the pressure on the account of the free movement in the fixing construction (not indicated in the figures) of the piezometric sensor (17).

The pressing force of the product (10), which is applied to the working table (2), is given by the operator in each certain case. In the general case, the heavier is the product (10), the more is its pressing force applied to the working table (2), which force may achieve several kilograms.

The product (10) is fed by means of the feeding rollers (15 and 19) to the first working zone, which is situated under the cutting tool (20) attached to the fixed spindle (4). When the product (10) appears in the working zone, adjustment of the pressing rollers (33) is provided. At the moment, when the product (10) appears under the pressing rollers (33), the operator uses the handle (42) to release fixation of the main platform (41), and by the force of gravity it slides down along the guides (not indicated in the figures) until the pressing roller (33) is restricted by the product (10).

Then the operator uses the handle (42) to fix the main platform (41) of the pressing roller (33) and turns the handle (43) of the cam (not indicated in the figures) by 180 degrees. Under the force of spring (37), the sliding platform (36) starts to produce pressure to the product (10) and the pressing rollers (33) fix the product (10) to the surface of the working table (2).

In the event that the product (10) is finished and no new one is fed yet, then the pressing roller (33) lowers only by the value of eccentricity (not indicated in the figures) and will be ready to take the following product (10). The free space under the cam (not indicated in the figures) will determine the value of free movement upwards in the event that the product (10) is somewhat thicker than the preceding one.

If it is necessary to increase the slope angle of the pressing roller (33) so that it would not be restricted by the working table (2), the pressing roller (33) should be taken of smaller width and attach the same to the relevant easily detachable plate (34). The whole adjustment process of the pressing roller (33) takes a few seconds. In the first working zone, the initial profiling of the product (10) takes place.

If the product (10) has been already profiled, then the fixed spindle (4) is switched off, and the product (10) is fed directly to the second working zone, which is situated under the cutting tools (20 and/or 23) attached to the first and second decorating spindle motors (5).

At first, the product (10) is fed under the cutting tool (20) attached to the first decorating spindle motor (5), where the initial decoration of the product (10) tales place.

If the product (10) does not need such processing, then the first decorating spindle motor (5) with the cutting tool (20) is switched off, and the product (10) is fed directly under the special cutting tool (23) attached to the second decorating spindle motor (5).

When the product (10) appears under any of the cutting tool (20 or 23), it is pressed by the pressing rollers (33). The cutting tool (23) on the shafts of the decorating spindle motors (5) and rotor adapter (24) rotates at high angular speed. The servodrives (27) for horizontal, vertical and angular movements of the platform (6) and tools (23), which receive the controlling signals from the computer (not indicated in the figures), permanently orient the rotation axis of the tools (23) at any angle to the product (10) and provide completion of a picture and/or relief of any complexity.

Production of a picture and/or relief may be provided in several modes. In the first mode, the product (10) moves at variable or fixed speed only forward. In this case, the cutting tool (23) makes monotonous movement or several monotonous movements combined in one unit by sense and program. In addition to the ordinary movement of the cutting tool (23), which may seem in the top view as a geometrical figure or resemble movement of an over-stitching needle in a sewing machine, the cutting tool (23) in the vertical plane can trace a complex outline of the product (10) in order to retain the uniform depth of cutting or, for example, move along an arc. The movement speed of the product (10) and cutting tool (23) is selected by the computer (not indicated in the figures) with respect to the provision of maximum working speed and good cutting quality. For example, in order to cut along straight line strictly across the product (10), it is necessary to move the cutting tool (23) in the direction of feeding the product (10) at the speed of such feeding. The movement of the product (10) itself in any material is determined by the kind of this material and by the type of the cutting tool (23), while the movement speed of the product (10) is selected in such a way to have enough time to cut the line and return to the initial position before coming to the point in the product (10), from which the following step of figure will start. If the feeding speed of the product (10) is higher, then the picture will run beyond the limits of the working window by coordinate X (along feeding the product (10)). The size of the working window is the processing zone determined by the maximum possible movement of the spindle motor (5) in the longitudinal and transverse directions (coordinates X and Y, respectively). If the feeding speed of the product (10) is lower, then at each step the cutting tool (23) will simply wait for the coming point, from which the following step of the picture will begin, and thus the working efficiency will decrease.

In the second mode, the product (10) stops, because a small complex picture is to be cut, and this work may take a relatively long period of time with respect to the picture. In this case, processing takes place only within the limits of the working window.

In the third mode, the product (10) moves forward and backward, significantly expanding the length of the working window, which becomes theoretically equal to the length of the product (10). In this case, the cutting tool (23) has its own movement. The same speeds of movement are provided as in the first mode.

The fourth mode means any combination of the aforementioned modes.

In the fifth mode, the movement limits and speeds of the cutting tool (23) by axes are determined as well as the feeding speed of the product (10). In this case, the operator will have an opportunity to switch on by one, two or three axes the random number generator (not indicated in the figures), an electronic device, which will in an absolutely random way determine the movement values of the cutting tool (23) by the relevant coordinate from zero to the maximum limit at the given amplitude. In this case, it will be possible to draw a picture, which will resemble a cutting made by a man rather than by a machine due to the absence of repeated patterns.

After processing in the second working zone, the product (10) is fed to the third working zone situated under the cutting tool (20) attached to the exit fixed spindle (4), where the top surface of the product (10) takes the final form of a picture and/or relief.

Then the product (10) is fed to the fourth working zone situated in the location zone of the round support (7). The spindle motor (8) moves over the round support (7) and processes the side and bottom surfaces of the product (10). Processing the bottom surface of the product (10) by the tool attached to the spindle motor (8) becomes possible due to the break (13) made in the working table (2).

From the fourth working zone, the product (10) exits in the form of the final product (45). If the fixed laser (44) is installed in the device, then one more working zone appears in the place, where the fixed laser (44) is installed, in which application of the mark, bar code, logotype etc. is provided along with drawing pictures, geometrical symbols and ornaments, which will be integrated into the already existing picture and/or relief.

In this case, one more working mode of the device appears where it is possible to switch off all the spindle motors (4, 5, and 8). In this mode, the device does not provide processing the product (10) but provides only marking thereof.

Therefore, this invention reduces the weight of moving parts, which fix and rotate the cutting tools (20 and 23); in this case, the working speed of the device is increased along with a significant decrease in the friction force against feeding the product (10) that enables to control the process better and more accurately, the service life of the cutting tools (20 and 23) is increased by many times on the account of continuous monitoring of the feeding speed and synchronization of the rotation frequency of the fixed spindles (4). Moreover, on the account of additional movement of the decorating spindle motor (5) in parallel to the surface of the product (10), there appears an opportunity to apply complex ornaments, to engrave numbers and letters on the product (10), as well as to execute additional technological operations, which were principally impossible for the earlier designed machine tools, such as strictly straight lines repeating the profile of the product (10) in the cross section or drilling the product (10) at an angle to the surface with the drilling axis sloped to the feeding direction, without stopping the product (10), and simultaneous marking the product (10) with the beam of the fixed laser (44) that simplifies the construction with higher quality of relief surface, on which any number of ornaments, patterns, pictures can be drawn at a high speed.

### INDUSTRIAL APPLICABILITY

This invention may be applied to production of high-art relief pictures, in particular, on wood materials.

Although the instant invention has been described in relation to particular embodiments thereof, many other variations and modifications and other uses will become apparent to those skilled in the art.

What is claimed is:

1. A device for preparation of relief surface on a product comprising:
a support base;
a working table disposed on said support base;
said working table having a
a mobile frame installed on said stationary base;
a product feeding device disposed on said working table wherein said product is fed in a direction through said device;
at least one spindle motor;
a shaft in mechanical communication with said at least one spindle motor;
said shaft having a holding collar to removeably hold a selected device; and
said shaft having a means for providing movement in three mutually perpendicular planes, wherein one of said mutually perpendicular planes being aligned to coincide with said direction.

2. The device for preparation of relief surface on a product according to claim 1 further comprising:
an interchangeable operating table opening disposed in said working table and beneath said selected device; and
an interchangeable operating table removeably inserted in said interchangeable operating table opening wherein said interchangeable operating table is selected to match a desired operation.

3. The device for preparation of relief surface on a product according to claim 1 wherein said interchangeable operating table includes a clamping means to hold said product.

4. The device for preparation of relief surface on a product according to claim 3 wherein said selected device is a servo drive having a tool holder disposed toward said product wherein high frequency movements are enabled.

5. The device for preparation of relief surface on a product according to claim 1 wherein said selected device is a standard tool attachment collar wherein a variety of tools are interchangeably held.

6. The device for preparation of relief surface on a product according to claim 2 wherein said interchangeable operating table includes a rotating section to moveably support said product.

7. The device for preparation of relief surface on a product according to claim 2 wherein said interchangeable operating table includes an air actuated clamping device to releasably hold said product.

8. The device for preparation of relief surface on a product according to claim 1 further comprising a plurality of drawers mounted to said support base.

9. The device for preparation of relief surface on a product according to claim 1 further comprising a computer control device in communication with said device wherein said computer control device is mounted on a multi-positional arm moveably disposed on a moveable control base.

10. The device for preparation of relief surface on a product according to claim 9 wherein said communication is a wired connection.

11. The device for preparation of relief surface on a product according to claim 1 further comprising:
a plurality of air channels disposed in said working table and parallel to said direction; and
an air coupling connected to an end of said plurality of air channels wherein when said air coupling is connected to an air source friction is reduced between said product and said working table.

12. The device for preparation of relief surface on a product according to claim 12 further comprising a second air coupling disposed on an opposite end of said plurality of air channels wherein air is introduced from both ends of said air channels.

13. The device for preparation of relief surface on a product according to claim 1 further comprising:
a plurality of rails disposed on said support base; and
at least one rail track holder disposed on said plurality of rails.

14. The device for preparation of relief surface on a product according to claim 14 further comprising a system unit disposed on said at least one rail track holder wherein said system unit is moveable between an operating position and a maintenance position.

15. The device for preparation of relief surface on a product according to claim 15 wherein said system unit comprises a blower unit.

16. The device for preparation of relief surface on a product according to claim 15 wherein said system unit comprises a vacuum pump unit.

17. The device for preparation of relief surface on a product according to claim 15 wherein said system unit comprises a liquid cooling unit.

18. The device for preparation of relief surface on a product according to claim 1 further comprising;
a rotating plate attached to an end of said working table;
a rotating means for selectively rotate said rotating plate wherein said working table is rotatable in a plane perpendicular to the plane of said direction.

19. The device for preparation of relief surface on a product according to claim 9 further comprising a feedback means mounted within a product working area for providing feedback to said control device.

20. The device for preparation of relief surface on a product according to claim 20 wherein said feedback means comprises at least one piezometric sensor.

21. The device for preparation of relief surface on a product according to claim 1 further comprising:
at least one mechanically controlled roller disposed on said working table; and
at least one product feeding feedback sensor wherein movement of said product is detected.

22. The device for preparation of relief surface on a product according to claim 9 wherein said selected device is an automatic tool changer; said automatic tool changer being controlled by said computer.

23. A method of preparing a relief surface on a product that is processed by profiling with a cutting tool rotated on a selected axis while simultaneously moving in a horizontal direction as directed by a program, the method comprising: orientating the rotational axis of said cutting tool with respect to said product at an angle selected from 0 to 360 degrees in three dimensions; orienting one of the dimensions so as to be parallel to a feeding direction of said product; selecting a product processing speed from 0 to a maximum in response to said program; selecting a rotational speed for said cutting tool in response to said program; and processing said product within an operational working area.

24. A method of preparing a relief surface on a product that is processed by profiling with a cutting tool rotated on a selected axis while simultaneously moving in a horizontal direction as directed by a program as claimed in claim 24 wherein said processing speed is selected to match a product feeding speed.

25. A method of preparing a relief surface on a product that is processed by profiling with a cutting tool rotated on a selected axis while simultaneously moving in a horizontal direction as directed by a program as claimed in claim 24 wherein said product is fed in a forward direction and a backward direction thereby effectively increasing said working zone to cover the entire length of said product.
